(19) United States
(12) Patent Application Publication
(10) Pub. No.: US 2008/0275909 A1
(43) Pub. Date: Nov. 6, 2008

(54) SYSTEMS AND METHODS FOR MANAGING IMAGE DATA AND METADATA

(75) Inventor: Andrew Rodney Ferlitsch, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/744,078

(22) Filed: May 3, 2007

(51) Int. Cl. G06F 17/30

(52) U.S. Cl. 707/103 R; 707/E17.055

(57) ABSTRACT

A method for managing image data and metadata is described. Image data is provided. Metadata associated with the image data is provided. A determination is made about the capabilities of a network and a destination. The image data and the metadata are encapsulated in an exchange format if the determined capabilities support encapsulation. The encapsulated image data and the metadata are transmitted to the destination over the network.

### TECHNICAL FIELD

The present invention relates generally to computers and computer-related technology. More specifically, the present invention relates to systems and methods for managing image data and metadata.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Imaging devices may provide image data that includes information about the image. Further, metadata may be provided that is information about the image data. The image data and the metadata may be transmitted to other imaging devices. The format in which the image data and metadata are transmitted may not be supported by the receiving imaging device. As such, benefits may be realized by providing systems and methods for managing image data and metadata. In particular, benefits may be realized by providing systems and methods for managing the transmission format of image data and metadata.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram illustrating one embodiment of a computing device that provides both image data and metadata associated with the image data;

FIG. 2 is one embodiment of a flow diagram illustrating a method for determining the format to transmit the image/metadata;

FIG. 3 is one embodiment of an environment of the present systems and methods;

FIG. 4 is a block diagram illustrating an image capable device providing image data and metadata;

FIG. 5 is a flow diagram illustrating a method for determining how to package metadata with image data;

FIG. 6 is a flow diagram illustrating one embodiment of a method of converting encoded metadata within image data to an XML encapsulated image/metadata message;

FIG. 7 is a block diagram illustrating the major hardware components typically utilized with embodiment herein; and

FIG. 8 is a network block diagram illustrating one possible environment in which the present systems and methods may be implemented.

### DETAILED DESCRIPTION

A method for managing image data and metadata is described. Image data is provided. Metadata associated with the image data is provided. A determination is made about the capabilities of a network and a destination. The image data and the metadata are encapsulated in an exchange format if the determined capabilities support encapsulation. The encapsulated image data and the metadata are transmitted to the destination over the network.

In one embodiment, the metadata is encoded within the image data if the determined capabilities do not support encapsulation. The image data and the metadata may be encapsulated in an extensible markup language (XML) message format. In another embodiment, the metadata is encoded as proprietary data within the image data. A uniform resource locator (URL) to the metadata may be encoded as proprietary data within the image data.

In one embodiment, the encoded metadata is transmitted through a public switched telephone network (PSTN). In addition, the encoded metadata may be transmitted through a file transfer protocol (FTP).

The destination may be queried to determine the capabilities of the destination. The capabilities of the network and the destination may be manually entered. The capabilities of the network and the destination may be predetermined knowledge. The encoded metadata may be converted into an encapsulated exchange format.

A computing device that is configured to manage image data and metadata is also described. The device includes a processor and memory in electronic communication with the processor. Instructions are stored in the memory. Image data is provided. Metadata associated with the image data is provided. The capabilities of a network and a destination are determined. The image data and the metadata are encapsulated in an exchange format if the determined capabilities support encapsulation. The encapsulated image data and the metadata are transmitted to the destination over the network.

A computer-readable medium is also described. The computer-readable medium includes executable instructions. Image data is provided. Metadata associated with the image data is provided. The capabilities of a network and a destination are determined. The image data and the metadata are encapsulated in an exchange format if the determined capabilities support encapsulation. The encapsulated image data and the metadata are transmitted to the destination over the network.

A method for converting a message from an encoded format to an encapsulated format is also described. A location of a schema identifier is located. Encoded metadata is extracted from image data according the schema identifier. The image data and the metadata are repackaged into an encapsulated exchange format.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

A growing number of modern imaging devices support the exchange of image data using some form of extensible markup language (XML) encapsulation; whereby, the XML includes some metadata. The metadata may be descriptive of some action (e.g., post-processing optical character recognition (OCR)) or meaning (e.g., owner, source location, etc.) to the image data.

Much of the XML format used for the exchange of image data is proprietary. Some web services exist which attempt to standardize these exchanges. However, many older traditional means of transmission, such as file transfer protocol (FTP) and public service telephone network (PSTN) fax and legacy devices (e.g., fax, printer, scanner, etc.) may not support an XML encapsulated image and/or XML encapsulated metadata.

Therefore, there is a desire to move XML encapsulated image/metadata transparently across end-points and transmission mediums, regardless of the degree of support. There is also a desire to retain the form and or meaning of the XML encapsulated image/metadata when it is transmitted across medians or reaches end-points which do support XML encapsulated image/metadata.

The present systems and methods describe an effective method to move image and metadata embedded into an XML format transparently across end-points and transmission methods. In one embodiment, when image and metadata is transported on a medium, or to an end-point that does not support XML encapsulated image/metadata, the image/metadata is stored in an image format only with the metadata transparently embedded in the image data. In another embodiment, when image and metadata is transported on a medium, or to an end-point that does support XML encapsulated image/metadata, the image/metadata is stored in an XML encapsulated image/metadata format.

In one embodiment, one or more source imaging devices generate image data; whereby, the image data may be transported over a variety of mediums, such as the PSTN, email, FTP and the Internet. Additionally, a user (or other means), may be able to enter metadata input at the imaging device. The metadata may be associated with the generated image data.

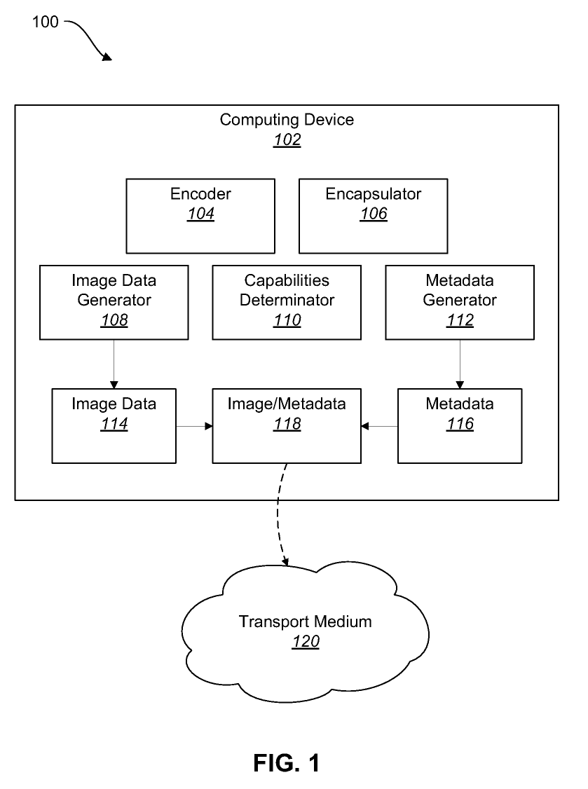

FIG. 1 is a block diagram 100 illustrating one embodiment of a computing device 102 that provides both image data 114 and metadata 116 associated with the image data 114. Some examples of image data 114 may include a network scan or a facsimile transmission. The computing device 102 may include a dual mode for transmission of the image data 114 and metadata 116 (collectively referred to as image/metadata 118). One of the modes for transmission of the image/metadata 118 may include the metadata 116 being encoded transparently within the image data 114 (e.g., proprietary fields in a Tagged Image File Format (TIFF)). An encoder 104 may encode the metadata 116 within the image data 114.

Another mode for transmission of the image/metadata 118 includes the image/metadata 118 being encapsulated within an XML message, such as a Direct Internet Message Encapsulation (DIME) format, according to a schema. An encapsulator 106 may encapsulate the image/metadata 118 within an XML message. When the metadata 116 is encoded within the image data 114 by the encoder 104, part of the encoding may include information on the schema for reconstructing the image/metadata 118 into an XML encapsulated message.

In one embodiment, the computing device 102 makes the decision of the format by which to transmit the image/metadata 118 according to what it can determine about a transport medium 120 and/or an end-point (not shown). The computing device 102 may include a capabilities determinator 110 that determines if the transport medium 120 and/or the end-point possess the capabilities to support XML encapsulated formats. If either the transport medium 120 or the end-point do not support XML encapsulated format, then the metadata 116 is encoded within the image data 114, such as when the image data 114 is transmitted using the PSTN or an unknown transport mechanism across the Internet. Otherwise, the image/metadata 118 is encoded in the XML encapsulated format.

If the image/metadata 118 reaches an end or intermediate point that supports the XML encapsulated format, the end or intermediate point determines the format of the image/metadata 118. In other words, the end or intermediate point determines if the format of the image/metadata 118 is an XML encapsulated format or an image format with encoded metadata embedded within. When the format is determined to be the image format with encoded metadata, the schema is extracted from the proprietary fields. The schema is used to extract the remaining metadata 116 and reconstruct the message as an XML encapsulated message. In one embodiment, the reconstructed XML encapsulated message may be interpreted or transported within its native format (e.g., Web Services).

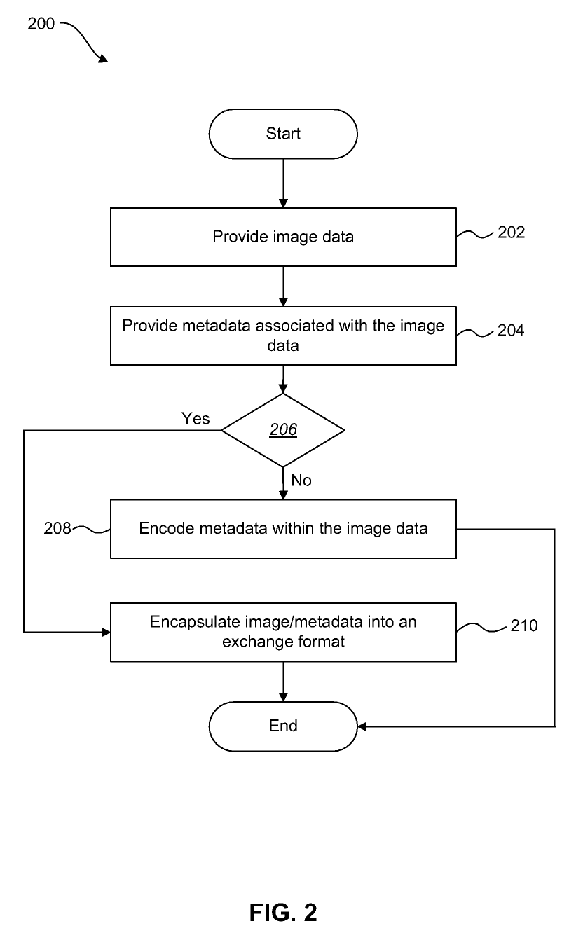

FIG. 2 is one embodiment of a flow diagram illustrating a method 200 for determining the format to transmit the image/metadata 118. In one embodiment, the method 200 is implemented by the computing device 102. Image data may be provided 202. In addition, metadata associated with the image data may be provided 204. A decision 206 is made whether a transport medium or an end-point supports an exchange format, such as an XML encapsulated format. If the transport medium and the end-point support the exchange format, the image data and metadata (image/metadata 118) is encapsulated 210 into the exchange format. In other words, the image/metadata 118 is encapsulated in the XML encapsulated format. However, if either the transport medium or the end-point does not support the exchange format, the metadata is encoded 208 within the image data.

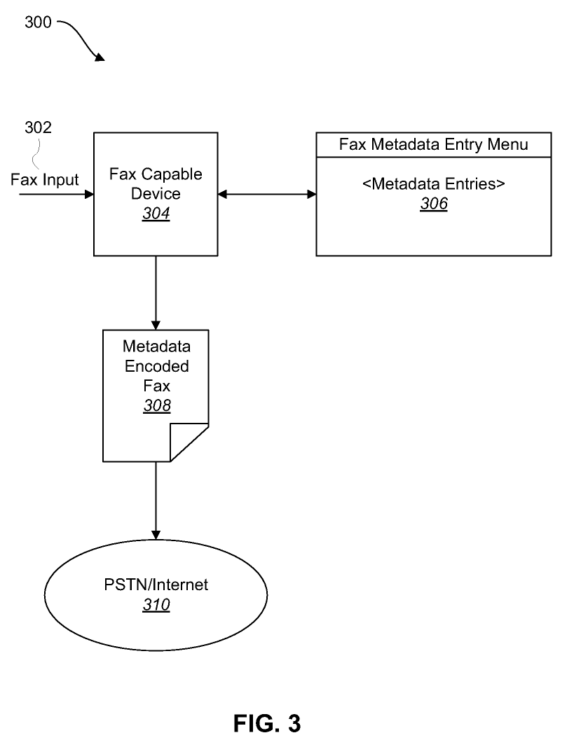

FIG. 3 is one embodiment of an environment 300 of the present systems and methods. The environment 300 includes one or more network connected devices capable of generating image data and exporting the image data over the network. The network may include the PSTN or the Internet 310. As illustrated, an example of a network connected device is a device 304 capable of faxing. Other examples of the device 304 include a document scanner, an electronic whiteboard, a filing device, a digital still or video camera, a video cell phone, a barcode scanner, an X-Ray device, a magnetic resonance imaging (MRI) device, a computed axial tomography (CAT) scan device, etc. The device 304 receives an input 302, such as a fax input. In addition, the device 304 may support the entry of metadata 306 that is associated with the image data. Metadata may be used for any purpose, such as commentary information about the image data (e.g., owner, computing device, etc.) and/or post-processing instructions (e.g., OCR). Examples of image data formats may include TIFF, TIFF-FX (facsimile), Joint Photographic Experts Group (JPEG), JPEG File Format (JFIF), JPEG 2000, Portable Network Graphics (PNG), Graphics Interchange Format (GIF), Windows bitmap (BMP), Windows High Definition bitmap (HD), Exchangeable Image File Format (EXIF), raster image, etc. The image data and metadata (image/metadata) may be transmitted to a destination (not shown) by any means, such as a communication channel that includes email, FTP, Hyper-Text Transfer Protocol (HTTP), DIME, Simple Object Access Protocol (SOAP), XML, proprietary protocol over Transmission Control Protocol (TCP)/Internet Protocol (IP), AppleTalk, PSTN, cable, etc. In the illustrated embodiment, the image/metadata is transmitted as a metadata encoded fax 308. The fax 308 is transmitted over the PSTN/Internet 310.

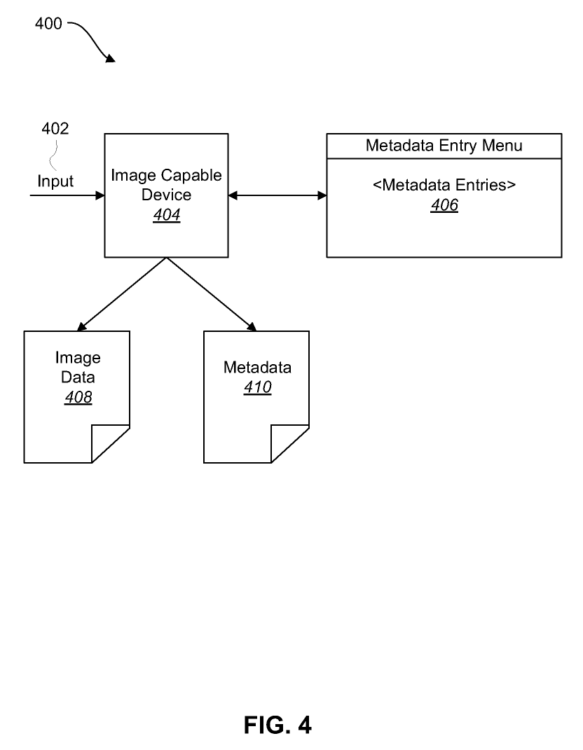

FIG. 4 is a block diagram 400 illustrating an image capable device 404 providing image data 408 and metadata 410. In one embodiment, an input 402 is provided to the image capable device 404. Image data 408 may be generated from the image device 404. In another embodiment, the image data 408 is retrieved from the image capable device 404. In addition, the device 404 may provide metadata 410. The metadata 410 may be part of metadata entries 406 that are provided to the device 404. In one embodiment, a user enters (or retrieves) metadata entries 406. The metadata entries 406 may be associated with the image data 408 as the metadata 410.

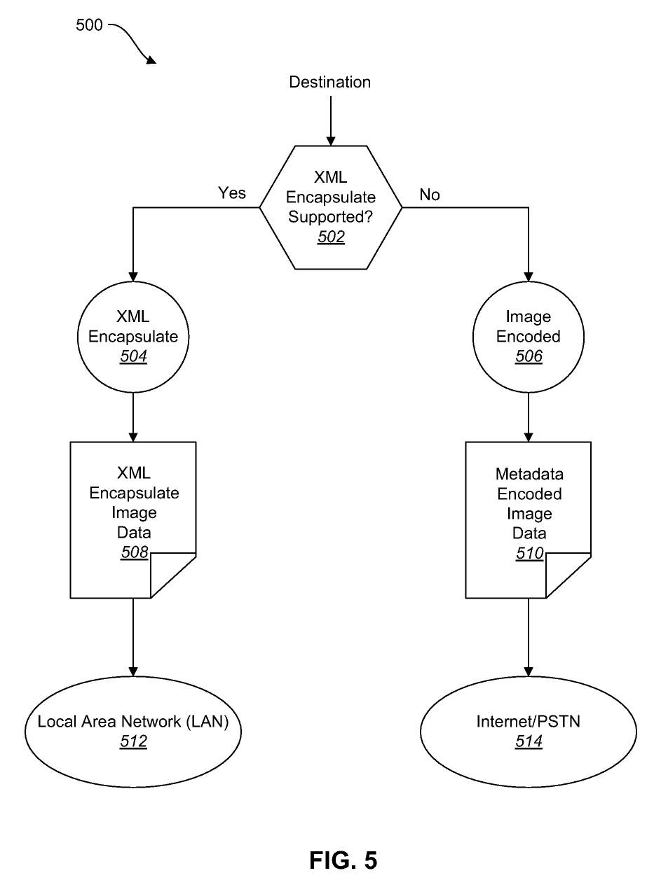

FIG. 5 is a flow diagram illustrating a method 500 for determining how to package metadata with image data. In one embodiment, the image capable device 404 implements the method 500. The device 404 may determine if the metadata is encoded as proprietary data within the image data. In addition, a uniform resource locator (URL) to the metadata may be encoded as proprietary data within the image data. Alternatively, the device 404 may encapsulate the metadata and image data within an XML message according to a schema.

As illustrated, a determination 502 is made if a destination (e.g., end-point) is capable of supporting XML encapsulation. If the destination is able to support XML encapsulation, the metadata and image data are encapsulated 504 within a message. The XML encapsulated message 508 may be transmitted over a local area network (LAN) 512. However, if it is determined 502 that the destination cannot support XML encapsulation, the metadata is encoded 506 within the image data. An encoded image data 510 with the metadata (image/metadata) may be transmitted over the Internet or PSTN 514.

In one embodiment, the image device makes the determination 502 based on its knowledge of the capabilities of the transport mechanism and end-points. For example, the image device may encode the metadata within the image data, such that it can be transparently transmitted, if the image/metadata is transmitted over the PSTN, sent through an unknown communication path via the Internet, the end or intermediate processing point does not support XML encapsulated image/metadata format or if FTP is implemented. The image device may determine 502 the capability to support XML messaging at the end or intermediate point, by any means, such as querying the end/intermediate point, predetermined knowledge of the end/intermediate point or information manually entered about the capabilities of the end/intermediate point.

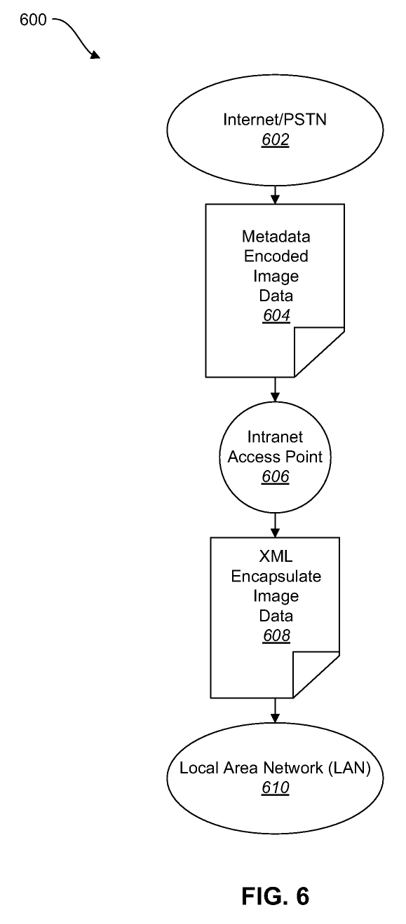

FIG. 6 is a flow diagram illustrating one embodiment of a method 600 of converting encoded metadata within image data to an XML encapsulated image/metadata message. The Internet or PSTN 602 may transmit metadata 604 that is encoded within image data. The encoded metadata 604 may be transmitted to an intranet access point 606. When the encoded metadata is received at the intranet access point 606, the behavior of the intranet access point 606 is dependent on the capability of the access point 606. For example, the intranet access point 606 may be an internet access server into an intranet, or a management device, such as a network print server.

If the intranet access point 606 is not capable of supporting XML encapsulated image/metadata format, the encoded metadata 604 is left unchanged. Otherwise, the intranet access point 606 (e.g., fax capable multifunction peripheral (MFP)) converts the encoded metadata 606 into an XML encapsulated image/metadata format 608. In order to convert the encoded metadata 606, the access point 606 may locate the location of a schema identifier, if any. The location may be predetermined or identified by a keyword. If no schema is located, the access point 606 may use a default method, such as a best guess. The encoded metadata is extracted from the image data according to the schema. The image data and metadata may be repackaged into an XML encapsulated format such as SOAP/XML, HTTP/DIME, etc. The XML encapsulated image data 608 may be processed/managed natively over a LAN 610.

While some embodiments have the metadata encoded in the image data, in an alternative embodiment, the metadata may instead reside at the originating source and an URL to the stored location may be encoded into the image data. When converted to XML encapsulated image/metadata, the URL may be extracted and the metadata is fetched using the URL (e.g., HTTP get, FTP).

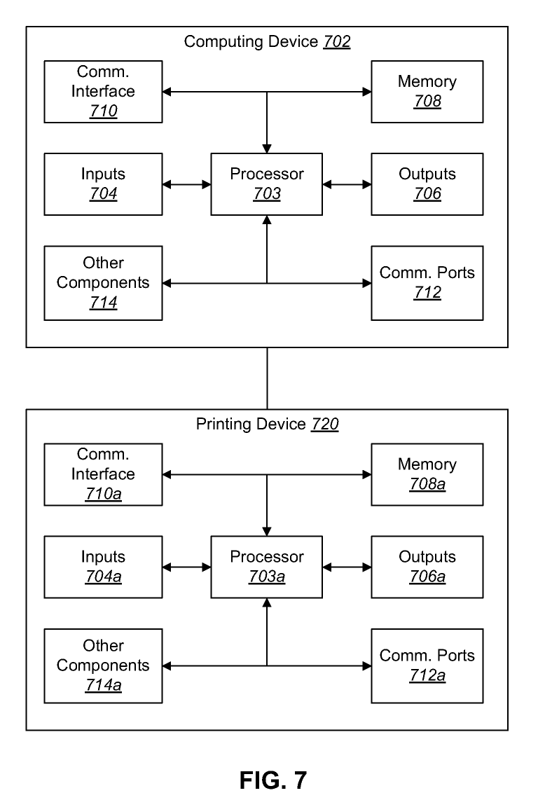

FIG. 7 is a block diagram illustrating the major hardware components typically utilized with embodiments herein. The systems and methods disclosed may be used with a computing device 702 and a printing device 720. The major hardware components typically utilized in a computing device 702 are illustrated in FIG. 7. A computing device 702 typically includes a processor 703 in electronic communication with input components or devices 704 and/or output components or devices 706. The processor 703 is operably connected to input 704 and/or output devices 706 capable of electronic communication with the processor 703, or, in other words, to devices capable of input and/or output in the form of an electrical signal. Embodiments of devices 702 may include the inputs 704, outputs 706 and the processor 703 within the same physical structure or in separate housings or structures.

The electronic device 702 may also include memory 708. The memory 708 may be a separate component from the processor 703, or it may be on-board memory 708 included in the same part as the processor 703. For example, microcontrollers often include a certain amount of on-board memory.

The processor 703 is also in electronic communication with a communication interface 710. The communication interface 710 may be used for communications with other devices 702, printing devices 720, servers, etc. Thus, the communication interfaces 710 of the various devices 702 may be designed to communicate with each other to send signals or messages between the computing devices 702.

The computing device 702 may also include other communication ports 712. In addition, other components 714 may also be included in the electronic device 702.

Many kinds of different devices may be used with embodiments herein. The computing device 702 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 7 is only meant to illustrate typical components of a computing device 702 and is not meant to limit the scope of embodiments disclosed herein.

The computing device 702 is in electronic communication with the printing device 720. A printing device 720 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, etc. A typical printing device, such as a physical printer, fax machine, scanner, multi-functional peripheral or copier is a type of computing device. As a result, it also includes a processor, memory, communications interface, etc., as shown and illustrated in relation to FIG. 7. The printing device may be a single or a plural grouping (e.g., pool or cluster) of two or more devices.

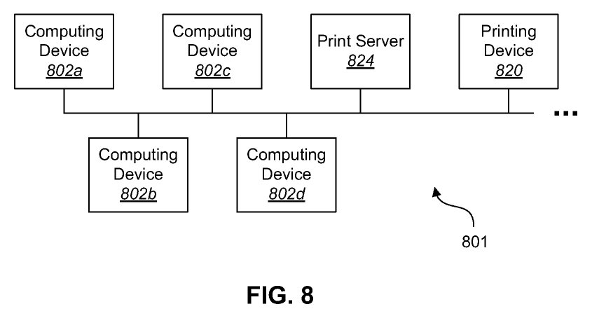

FIG. 8 is a network block diagram illustrating one possible environment in which the present systems and methods may be implemented. The present systems and methods may also be implemented on a standalone computer system. FIG. 8 illustrates a computer network 801 comprising a plurality of computing devices 802, a printing device 820 and a print server 824.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for managing image data and metadata, the method comprising:
providing image data;
providing metadata associated with the image data;
determining the capabilities of a network and a destination;
encapsulating the image data and the metadata in an exchange format if the determined capabilities support encapsulation; and
transmitting the encapsulated image data and the metadata to the destination over the network.

2. The method of claim 1, further comprising encoding the metadata within the image data if the determined capabilities do not support encapsulation.

3. The method of claim 1, wherein the image data and the metadata are encapsulated in an extensible markup language (XML) message format.

4. The method of claim 2, wherein the metadata is encoded as proprietary data within the image data.

5. The method of claim 2, wherein a uniform resource locator (URL) to the metadata is encoded as proprietary data within the image data.

6. The method of claim 2, wherein the encoded metadata is transmitted through a public switched telephone network (PSTN).

7. The method of claim 2, wherein the encoded metadata is transmitted through a file transfer protocol (FTP).

8. The method of claim 1, further comprising querying the destination to determine the capabilities of the destination.

9. The method of claim 1, wherein the capabilities of the network and the destination are manually entered.

10. The method of claim 1, wherein the capabilities of the network and the destination are predetermined knowledge.

11. The method of claim 2, further comprising converting the encoded metadata into an encapsulated exchange format.

12. A computing device that is configured to manage image data and metadata, the computing device comprising:
a processor;
memory in electronic communication with the processor;
instructions stored in the memory, the instructions being executable to:
provide image data;
provide metadata associated with the image data;
determine the capabilities of a network and a destination;
encapsulate the image data and the metadata in an exchange format if the determined capabilities support encapsulation; and
transmit the encapsulated image data and the metadata to the destination over the network.

13. The device of claim 12, wherein the instructions are further executable to encode the metadata within the image data if the determined capabilities do not support encapsulation.

14. The device of claim 12, wherein the image data and the metadata are encapsulated in an extensible markup language (XML) message format.

15. The device of claim 13, wherein the metadata is encoded as proprietary data within the image data.

16. The device of claim 13, wherein a uniform resource locator (URL) to the metadata is encoded as proprietary data within the image data.

17. The device of claim 13, wherein the encoded metadata is transmitted through a public switched telephone network (PSTN).

18. The device of claim 13, wherein the encoded metadata is transmitted through a file transfer protocol (FTP).

19. A computer-readable medium comprising executable instructions for:
providing image data;
providing metadata associated with the image data;
determining the capabilities of a network and a destination;
encapsulating the image data and the metadata in an exchange format if the determined capabilities support encapsulation; and
transmitting the encapsulated image data and the metadata to the destination over the network.

20. A method for converting a message from an encoded format to an encapsulated format, the method comprising:
locating a location of a schema identifier;
extracting encoded metadata from image data according the schema identifier; and
repackaging the image data and the metadata into an encapsulated exchange format.
